(19) United States
(12) Patent Application Publication
(10) Pub. No.: US 2007/0239510 A1
(43) Pub. Date: Oct. 11, 2007

(54) Adhesive applique iterative calendar system

(76) Inventor: Beth Lynn Fischer, Star Prairie, WI (US)

Correspondence Address: Beth Lynn Fischer, 11 Highway 65, Star Prairie, WI, 54026, US

(21) Appl. No.: 11/398,898

(22) Filed: Apr. 7, 2006

(51) Int. Cl. G06F 9/46

(52) U.S. Cl. 705/9

(57) ABSTRACT

The invention is a new tool that allows for a new approach by which two parties create a schedule. The invention is a self-contained portable calendar system based on the use of reusable adhesive appliqués on a series of month-at-a-glance calendar pages. The representation of the two parties by two primary colors or styles of appliqués is new. This feature eliminates the need for writing utensils and personal computers and therefore allows for easy iterations during formation of the schedule. In summary, the invention is a new tool for creating a two-party schedule, and at the end of the iterative process it also becomes a new tangible, easy-to-understand representation of that schedule.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A TABLE OF DATA

Not Applicable.

### BACKGROUND OF THE INVENTION

The invention pertains to the field of endeavor of two-party advance scheduling of shared care for one or more dependents. The most common specific application is shared parental custody of one or more minor dependents.

The invention was borne out of a strong desire to reduce conflict and stress prior to and during family court litigation related to divorce. The prior art lacks the element of advance schedule planning and instead is typically based on mediation which, if unsuccessful, results in determination and assignment by the presiding judge of the number of “overnights” for which each party will be responsible for the care of the minor dependent(s). The prior art thus establishes a basis for ongoing conflict between the estranged parties, because it fails to distribute the number of “overnights” into an actual schedule, and also because it requires the estranged parties to maintain more contact with each other than would otherwise need to occur, therefore exacerbating conflictive situations.

The following problems are often encountered with the prior art:
The prior art relies on exchanges between the estranged parties that are face-to-face, over the telephone, or in the presence of mediators or attorneys. The resulting stress and even hostility are not conducive to timely, peaceful creation of a schedule for sharing the care of the minor dependent(s).
The prior art is not conducive to the early creation of the shared care schedule. Determination of this schedule is frequently allowed to languish for weeks or months while repeated hearings take place, some of which do not even address the shared care schedule.
The prior art is not conducive to a long-term approach to the shared care schedule. Parties are expected to work out a schedule based on the number of “overnights” that are either mediated or court-ordered, but the parties are not provided with any tools to assist with this task. This often results in piece-meal scheduling of relatively short time periods, leaving significant potential for additional court hearings in order to create and/or edit the upcoming days or weeks of the schedule.
The prior art does not generate any tangible item that is either understandable by, or comforting to, the minor dependent(s) involved. Thus the child or children typically perceive only prolonged fighting between parents over the schedule for spending “overnights” with their mother and their father.

### BRIEF SUMMARY OF THE INVENTION

The claimed invention, the “Adhesive Appliqué Iterative Calendar System”, is an advance scheduling system which utilizes reusable adhesive appliqués placed onto month-at-a-glance calendars. The appliqués are of two different colors or styles and represent each of the two responsible adult parties that will be sharing in the care of the minor dependent(s); often these parties are referred to as co-parents. In addition, the system utilizes special occasion and event reusable adhesive appliqués to capture dates significant to the minor dependent(s) and therefore important to both co-parents.

The objective of the invention is to provide the following:
A simple, low-stress, iterative solution for advance scheduling of one year of the shared care of a minor dependent(s).
A tangible schedule that can be easily understood by children.
An all-inclusive schedule, useful to adults, that can accompany the minor dependent(s) to each co-parents' residence, daycare, school, etc.

The invention represents an improvement over the prior art in two key aspects: fewer verbal exchanges between estranged parties, and emphasis on long-term advance planning. The invention offers the following specific advantages compared to the prior art:
Although some level of communication between estranged parties is still required, that communication does not need to be face-to-face, over the telephone, or in the presence of mediators or attorneys. Each party can study and utilize this tangible, visual, iterative system in the relative peacefulness of his or her own residence.
The invention is an easy-to-use tool that can be utilized very early in any family litigation case, independent of attorneys and mediators. This significant advantage supports the fundamental objective of establishing the shared care schedule first and foremost, before attempting to resolve any of the multitude of other family litigation matters.
The invention has a long-term perspective that necessarily causes the parties to note the actual occurrence of holidays, birthdays, etc. during that year. This can encourage an effective overall shared care schedule for the entire year, not simply a rigid schedule based on strict cyclic intervals.
The invention can be utilized before, during, or after mediation. The invention does not require the court to order the number of “overnights”, but it is easily utilized in situations where such ordering occurs.
The invention not only helps solve a family litigation matter, it also provides the responsible parties with a meaningful, useful schedule that can be consulted throughout the entire year as needed.
The invention results in a tangible schedule that is simple enough for even young children to comprehend. The child only needs to remember that primary color/style “A” is for one parent, and “B” is for the other.

### BRIEF DESCRIPTION OF THE SEVERAL VIEWS OF THE DRAWING

FIG. 1—A depiction of one full sheet of primary-color reusable adhesive appliqués, as-manufactured, prior to first use.

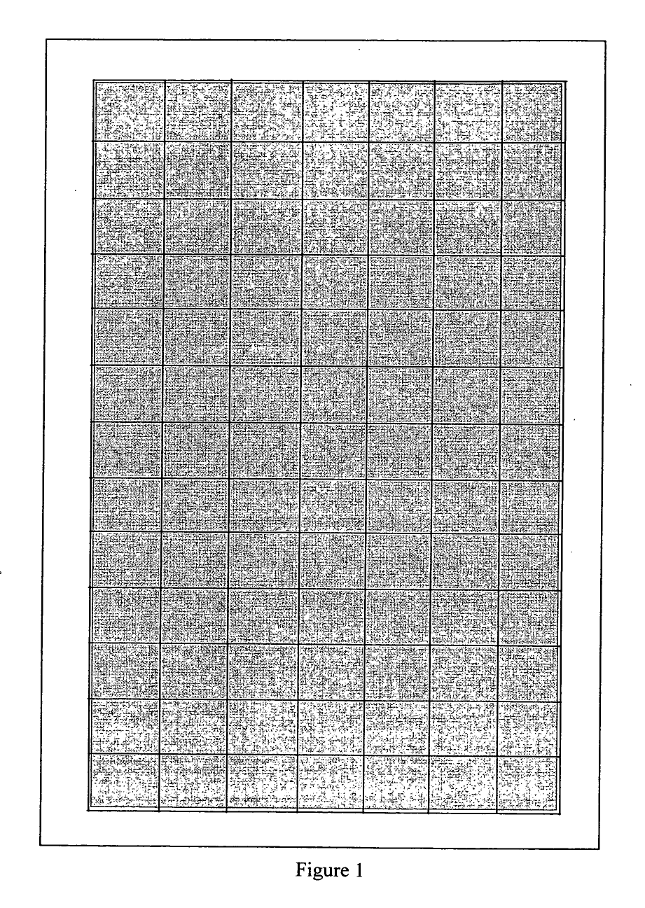

FIG. 2—A depiction of one full sheet of special occasion/event reusable adhesive appliqués, as-manufactured, prior to first use.

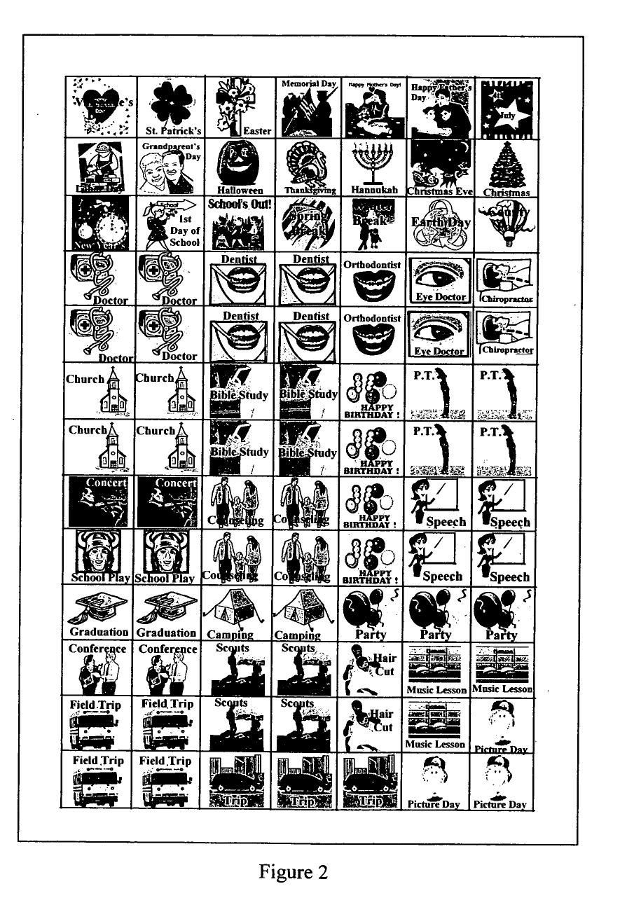

FIG. 3—A depiction of one calendar sheet, as printed, prior to first use. Daily numbers are intentionally omitted from the calendar sheets, as these numbers are later written by the user, either directly onto the calendar sheets or directly onto the primary-color reusable adhesive appliqués.

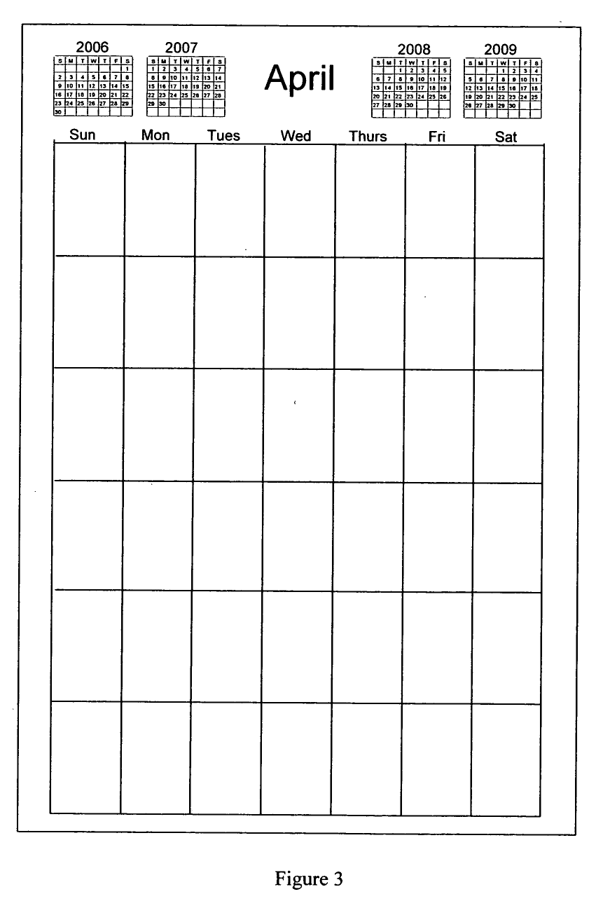

FIG. 4—A representation of the application of primary adhesive appliqués to one calendar sheet. One primary color represents one adult caregiver; the other color represents the other adult caregiver. (For clarity, some calendar sheet details have been omitted from FIG. 4.)

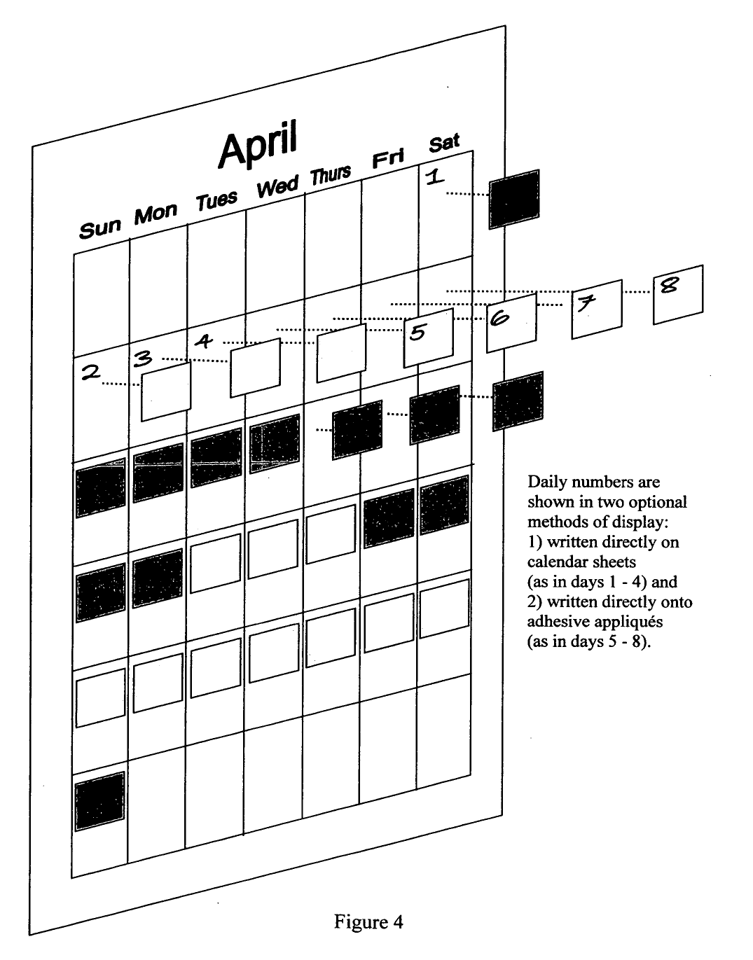

FIG. 5—A depiction of one completed calendar sheet showing both primary-color and special event/occasion adhesive appliqués. (For clarity, some calendar sheet details have been omitted from FIG. 5.)

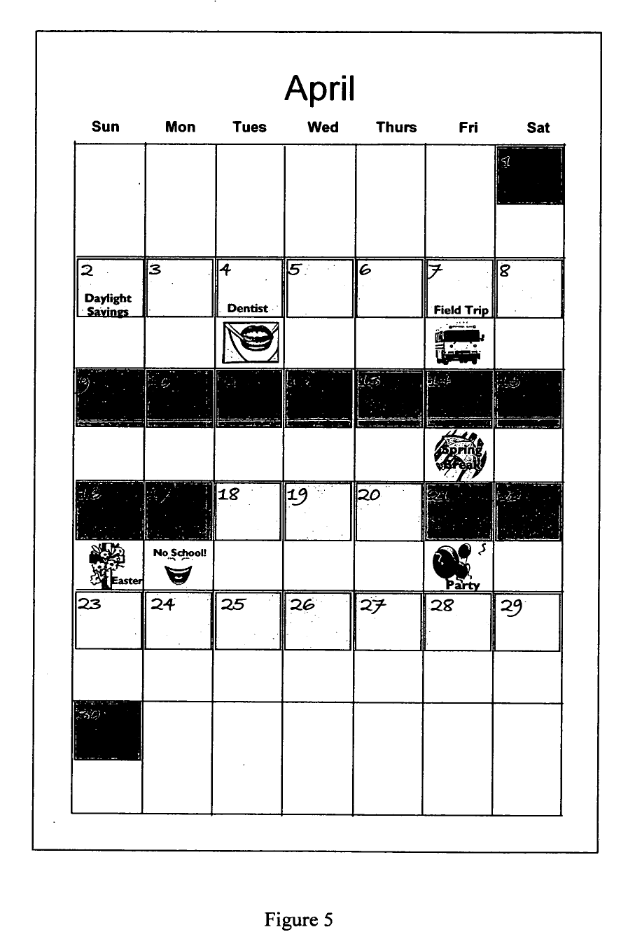

### DETAILED DESCRIPTION OF THE INVENTION

The invention is a calendar system consisting of a 12-month, month-per-page calendar and at least 366 non-permanent adhesive appliqués, half of which are of one color or distinct style and half of which are of another color or another distinct style. In addition, the system contains special occasion and event non-permanent adhesive appliqués to capture dates significant to the minor dependent(s) and therefore important to both co-parents. This calendar system invention can be used alone or as a complement within a planner or similar publication.

Specification details for calendar pages include the following:
Month-at-a-glance calendar pages are to be 8½″+/−2″×5½″+/−1″
Calendar pages are to be printed on paper or rigid plastic film. If paper is used, the paper is to have surface properties and adequate stiffness such that the paper will not delaminate when the non-permanent adhesive appliqués are applied and subsequently removed.
Each rectangular box representing a day on a calendar page is to be at least 1.75 times as tall as its width.
If calendar pages are formatted to specific months of a specific year, the numbers printed inside each daily box are to be top-justified or bottom-justified and are to occupy less than one quarter of each individual box's area.
If calendar pages are not formatted to specific months, there shall be one page titled for each month, and each page shall contain five rows of seven boxes each. Numbers subsequently written by the user are to be top-justified or bottom-justified in each box and are to occupy less than one quarter of each individual box's area

Specification details for non-permanent adhesive appliqués include the following:
Adhesive appliqués are to be based on thin polymer film and are to be reusable on suitable paper or suitable rigid plastic film.
Adhesive appliqués are to be die-cut or otherwise scored as needed to allow their individual removal from the backing substrate, which is to have the same overall size as the month-at-a-glance calendar pages.
The area of each individual adhesive appliqué is to be not less than one third nor more than three quarters of the area of each rectangular daily box on a calendar page.
All adhesive appliqués are to fall into one and only one of the following three categories:
Color or distinct style “A”, numbering at least 183 pieces but not individually serialized
Color or distinct style “B”, numbering at least 183 pieces but not individually serialized
Holiday, special occasion, event, and appointment indicators, containing copyright-free figures and/or text as appropriate. These appliqués are to be the same size and shape as appliqués “A” and “B”.

All calendar pages and all pages of adhesive appliqués are to be bound together, either as a stand-alone assembly or as part of another publication.

Explanation of use:

One party uses one color or style of the non-permanent adhesive appliqués to represent their desired schedule of caring for the dependent(s). As an example, in most divorce litigation cases this schedule represents the “overnights” for the dependent(s) to be spent at each adult party's residence. Therefore one adult party places appliqués on calendar pages to represent the number of days and the specific days that they plan to, and/or are court-ordered to, care for the dependent(s). When finished, the adult party makes a photocopy or some other record of this initial proposed schedule.

The calendar system, often contained within a planner or similar complementing publication, is then provided to the second adult party. The second party uses the other color or style of non-permanent adhesive appliqués to represent their desired schedule and attaches same to calendar pages. By doing so, the second party is also reviewing the schedule proposed by the first party.

In cases where full agreement on the schedule is not initially achieved, the second party proposes changes to the first party's schedule by rearranging certain appliqués that had been applied by the first party. The second party then makes a photocopy or some other record of the revised proposed schedule, and returns the calendar system to the first party for review. The first party then agrees or proposes changes by rearranging appliqués. This iterative process continues until both parties arrive at a mutually agreeable schedule for caring for the dependent(s). This iterative process does not require writing utensils, personal computers, or third parties. The calendar system ultimately becomes the single, visual and tangible representation of the schedule, easily shared with children if desired.

Method of Production for Adhesive Appliqués of primary colors or styles:

A sheet medium of non-permanent adhesive film on an appropriate backing substrate is used for producing the appliqués. First, a page size that will be included in the finished calendar system is determined. Next the printing area(s) is determined, based on allowing for appropriate margins around what will be the final page size. Printing is done, in most cases, with a single-color process. Two-or four-color processes are used if the chosen colors or styles for the appliqués require their use. Printed sheets are then cut as needed to achieve the final page size, retaining appropriate margins. Next all pages are scored with a die through the adhesive film only. The die scoring process establishes the size of each individual scored section and thus establishes the number of usable appliqués per page of non-permanent adhesive film. At least one edge of each final page must have adequate margin allowance for spiral coil binding. This process of printing, cutting to size, and die scoring is repeated as needed in order to generate at least 183 usable appliqués of one color or style and at least 183 usable appliqués of another color or style.

Method of Production for Adhesive Appliqués of special event styles:

Production of special event non-permanent adhesive appliqués requires the same sheet medium as production of primary color/style appliqués. However, unlike primary color/style appliqués, the individual size and page layout for special event appliqués must be determined before any printing can occur. The size and page layout, including appropriate margins, are most conveniently established using word processing or desktop publishing software. After these details are determined, the sheet size for printing is chosen, so that the final page size and layout will match what will be printed. Important consideration must also be given to the die scoring process, as the score marks must match the boundaries of each individual printed appliqué on the final page. As with primary color/style appliqués, the scoring must only go through the adhesive film. At least one edge of each final page must have adequate margin allowance for spiral coil binding. The process of printing, cutting to size, and die scoring is repeated as needed, based solely on the number and layout of special event appliqués as previously determined using word processing or desktop publishing software.

Method of Production for Calendar Pages:

The content and layout of calendar pages are most easily established using word processing or desktop publishing software. The sheet medium for calendar pages must have surface properties and adequate stiffness such that the medium will not delaminate when the non-permanent adhesive appliqués are applied and subsequently removed. Calendar pages are printed on sheets and then cut to size as needed, or are printed as individual pages. Printing is usually done using a single-color process. At least one edge of each final page must have adequate margin allowance for spiral coil binding. The process of printing and cutting to size if needed is repeated until twelve final calendar pages have been produced.

1. I claim the subject matter of the invention to be a portable calendar system intended to be used by two adult parties to iteratively create a single, year-long schedule for the shared care of one or more minor dependents.

2. I claim that the physical objects comprising the invention include the following:
At least 366 non-permanent adhesive appliqués, half of which are of one primary color/style and half of which are of another primary color/style
An arbitrary number of non-permanent adhesive appliqués that depict holidays, special occasions, and other events important to a typical minor dependent(s) and/or relevant to the schedule of shared care for said dependent(s)
One year of month-at-a-glance calendar pages, printed on a medium suitable for repeated application and removal of the non-permanent adhesive appliqués 3. I claim the following as representing the scope of protection regarding the invention:
The use of non-permanent adhesive appliqués of two primary colors or styles, which are placed onto a series of month-at-a-glance calendar pages in order to create a schedule
The iterative changing of preliminary schedules without the need for writing utensils or a personal computer
The use of non-permanent adhesive appliqués to depict holidays, special occasions, and other events relevant to the preliminary and/or final schedule
The iterative changing, where possible, of the occurrence of special occasions and events without the need for writing utensils or a personal computer
The visual and tangible representation of the schedule, whether preliminary or final, including holidays, special occasions, and events relevant to the schedule
The portability of the system
The inclusion of all reusable adhesive appliqués and all calendar pages within the system, making it self-contained
The ease of adaptability of the system into complementary publications
